(19) United States
(12) Patent Application Publication
(10) Pub. No.: US 2011/0176400 A1
(43) Pub. Date: Jul. 21, 2011

(54) METHOD OF SERVO SPIRAL SWITCHING DURING SELF SERVO-WRITE FOR A DISK DRIVE

(76) Inventor: Anton L. GERASIMOV, Santa Clara, CA (US)

(21) Appl. No.: 12/690,012

(22) Filed: Jan. 19, 2010

(51) Int. Cl. G11B 20/00

(52) U.S. Cl. 369/47.15; G9B/20

(57) ABSTRACT

A recording medium for a disk drive has a plurality of tracks defined by servo wedges that are written using a first servo spiral set, a second servo spiral set, and a correction factor that accounts for the differences in the first set of spirals and the second set of spirals. The differences may be differences in position values decoded from the first set of spirals and position values decoded from the second set of spirals or differences in timing values decoded from the first set of spirals and timing values decoded from the second set of spirals. The first servo spiral set is used in writing components of the servo wedges that define a first set of tracks. The second servo spiral set and the correction factor are used in writing components of the servo wedges that define a second set of tracks.

### BACKGROUND OF THE INVENTION

1. Field of the Invention

Embodiments of the present invention relate generally to disk drives and, more particularly, to a method of servo spiral switching during self servo-write for such drives.

2. Description of the Related Art

A disk drive is a data storage device that stores digital data in concentric tracks on the surface of a data storage disk. Data is read from or written to a desired track using a transducer, which includes a read head and a write head, that are held proximate to the track while the disk spins about its center at a constant angular velocity. To properly align the transducer with a desired track during a read or write operation, a closed-loop servo system is generally implemented that relies on servo data stored in servo sectors written on the disk surface when the disk drive is manufactured. These servo sectors form “servo wedges” or “servo spokes” from the outer to inner diameter of the disk, and are either written on the disk surface by an external device, such as a servo track writer or by the drive itself using a self servo-writing procedure.

External servo track writers employ extremely accurate head positioning mechanics, such as a laser interferometer or optical coder, to ensure that servo wedges are written at the proper radial position on a disk. External servo track writers are expensive and must be operated in a clean room environment to prevent contamination of the disk. Therefore, it is desirable to minimize the time each disk spends on an external servo track writer. Because modern disk drives typically include hundreds of thousands of tracks, the use of external servo track writers can be a prohibitively time-consuming part of the manufacturing process. Consequently, various self servo-writing schemes have been developed in the art, in which the internal electronics and servo system of a disk drive are used to write final servo wedges onto a disk, rather than an external servo track writer.

In order for a disk drive to perform self servo-write, position and timing information must be provided to the disk drive servo system so that it can write the final servo wedges onto the disk with the necessary precision for proper operation of the disk drive. To that end, an external servo track writer may be used to write a plurality of spiral tracks or “servo spirals” to the disk, where these servo spirals contain sufficient timing and position information for the internal servo system of the disk drive to subsequently write the final servo wedges on the disk by self-servo write (SSW). Because the requisite servo spirals can be written on a disk relatively quickly, the time each disk spends on the external servo track writer is minimized. During SSW, the disk drive servo system uses the timing and position information contained in the servo spirals to servo precisely over the radial position on the disk corresponding to each data storage track and thereby write the final servo wedges onto the disk one radial position at a time. Specifically, the read head of the disk drive is used to read position and timing information from the servo spirals and the write head is used to write the final servo wedges.

Generally, two or more complete sets of servo spiral sets are typically written on a disk prior to SSW, where each servo spiral sets includes at least one servo spiral for each final servo wedge to be written during SSW. This is because a single set of servo spirals cannot continuously provide position and timing information as required during SSW, and servo control of the read/write head is typically switched from one servo spiral set to another throughout SSW. Switching between servo spiral sets is generally necessary for two reasons. First, the read head and write head of a disk drive are typically positioned in such a way that when the write head writes the portions of the final servo wedges near the OD of a disk, the read head is typically “behind” the write head. That is, the read head reads timing and position information from a region of a servo spiral track that has already had final servo wedge information written thereto by the write head. Thus, during SSW near the OD of a disk, the servo spirals that the read head uses for servoing the read and write heads are overwritten in some radial locations by the newly written final servo wedges. Consequently, as the read head nears such a radial location, information for servo control must be changed to a second set of servo spirals that have not been overwritten by final servo wedges at that radial location. Second, only one operation, i.e., either READ or WRITE, can be executed at a given time by the read/write head. During SSW, this means that everywhere across the disk surface servo information from the media cannot be read by the read head at the same time that the write head is writing servo wedges, so the servo control, which involves a READ operation, must be changed periodically to a second set of servo spirals that have not been overwritten by final servo wedges during a previous WRITE operation. Thus, two or more complete sets of servo spiral sets are typically written on a disk prior to SSW, where each servo spiral sets includes at least one servo spiral for each final servo wedge to be written during SSW. Servo control during SSW alternates between the two or more servo spiral sets as required when the read head approaches a radial location at which the current servo spiral set has been overwritten by final servo wedges. In this way, servo control of the radial position of the write head, and therefore the radial position of the final servo wedges, is maintained for all radial track locations.

One issue with the SSW process described above is that, although each servo spiral is written on a disk with relatively high accuracy by means of an external servo track writer, a certain amount of variation in the path of each servo spiral is known to occur. Such servo spiral variation may be caused by random factors, such as imperfections in either the disk media or in the position control of the external servo track writer while writing the servo spirals. Servo spiral variation may also be the result of factors that affect adjacent tracks similarly and change slowly across the disk surface, such as disk eccentricity, clamping distortions, and other factors that alter the shape of relatively large portions of the disk. The cumulative effect of these spiral-to-spiral variations is that the actual path followed by the read/write head while servoing off a servo spiral set is not an ideal circular path, and final servo wedges will be written along this non-circular path. If only a single servo spiral set were used for servoing during SSW, the non-ideal shape of the final tracks would not significantly affect disk drive performance. However, because servo control must be switched between multiple servo spiral sets during SSW, problems arise in the performance of disk drives with SSW written final servo wedges, as illustrated in FIG. 1.

FIG. 1 is a partial schematic view of a plurality of final data tracks 70 defined by final servo wedges written during SSW. A first servo spiral set was used to servo a disk drive write head while writing the final servo wedges for a first track set 80 and a second servo spiral set was used to servo the disk drive write head while writing the final servo wedges for a second track set 90. For clarity, final servo wedges and servo spiral sets have been omitted from FIG. 1, and for reference an ideal circular path 95 has been indicated. First track set 80 includes a plurality of data tracks that follow non-ideal, but substantially parallel paths. Similarly, second track set 90 includes a plurality of data tracks that follow non-ideal, but substantially parallel paths. As shown, relative radial final track position inaccuracy between first track set 80 and second track set 90 is poor and typically leads to undesirable position error signal (PES) spikes and poor signal coherency during otherwise normal operation of the disk drive.

In light of the above, there is a need in the art for a method of servo spiral switching during self servo-write for a disk drive.

### SUMMARY OF THE INVENTION

One or more embodiments of the present invention provide a method for writing servo wedges on a recording medium having first and second servo spirals written thereon. In the method, a correction factor is used to account for differences in position and/or timing values decoded from the first and second servo spirals. As a result of applying the correction factor, relative position accuracy and signal coherency issues with servo wedges written using servo spirals are reduced.

A method of writing servo wedges on a recording medium having first and second sets of spirals written thereon, according to an embodiment of the present invention, includes the steps of writing components of the servo wedges on the recording medium at a first radial position of the recording medium based on values decoded from the spirals in the first set, and writing components of the servo wedges on the recording medium at a second radial position of the recording medium based on values decoded from the spirals in the second set. Correction factors are determined from differences between the first and second sets of spirals, in particular differences in the values decoded from the spirals in the first set and the values decoded from the spirals in the second set, and applied to one or both of the values decoded from the spirals in the first set and the values decoded from the spirals in the second set.

A method of writing servo wedges on a recording medium having first and second servo spirals written thereon, according to an embodiment of the present invention, includes the steps of collecting information from the first servo spiral and the second servo spiral, positioning a transducer head over a first radial position of the recording medium and writing components of the servo wedges on the recording medium at the first radial position using the information collected from the first servo spiral, and positioning the transducer head over a second radial position of the recording medium and writing components of the servo wedges on the recording medium at the second radial position using the information collected from the second servo spiral. The collected information may be position information or timing information and may be modified using a correction factor, which may be a position correction factor or a timing correction factor.

A recording medium for a disk drive, according to an embodiment of the present invention, has a plurality of tracks defined by servo wedges that are written using a first servo spiral set, a second servo spiral set, and a correction factor that accounts for the differences in the first set of spirals and the second set of spirals. The differences may be differences in position values decoded from the first set of spirals and position values decoded from the second set of spirals or differences in timing values decoded from the first set of spirals and timing values decoded from the second set of spirals. The first servo spiral set is used in writing components of the servo wedges that define a first set of tracks. The second servo spiral set and the correction factor are used in writing components of the servo wedges that define a second set of tracks.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a partial schematic view of a plurality of final data tracks defined by final servo wedges written during SSW.

FIG. 2 is a perspective view of a disk drive that can benefit from embodiments of the invention as described herein.

FIG. 3 illustrates a storage disk with data organized in a typical manner known in the art.

FIG. 4 illustrates a storage disk prior to undergoing a SSW process.

FIG. 5 is a partial schematic diagram of servo wedges in the process of SSW.

FIG. 6 is a flow chart that summarizes a method for switching servo control from an active servo spiral set to an inactive servo spiral set, according to an embodiment of the invention.

FIG. 7 is a partial schematic diagram of a storage disk after a method has been performed according to an embodiment of the invention, and concentric data storage tracks have been written on the storage disk.

FIGS. 8A, 8B illustrate PES samples taken, respectively, from a disk drive manufactured using a standard SSW procedure and an identical disk drive using an SSW procedure modified by an embodiment of the invention.

FIGS. 9A, 9B illustrate automatic gain control (AGC) samples taken, respectively, from a disk drive manufactured using a standard SSW procedure and an identical disk drive using an SSW procedure modified by an embodiment of the invention.

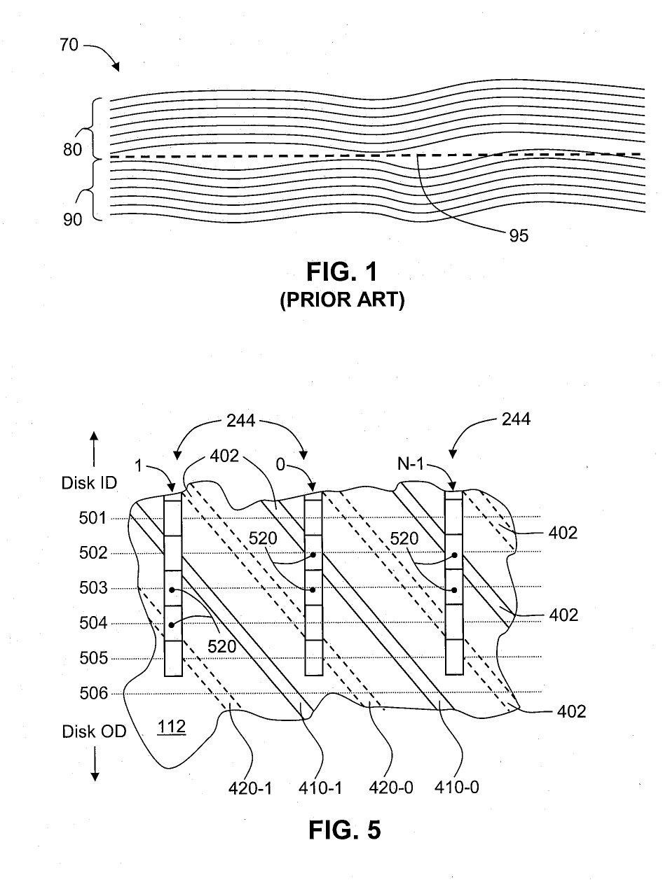

For clarity, identical reference numbers have been used, where applicable, to designate identical elements that are common between figures. It is contemplated that features of one embodiment may be incorporated in other embodiments without further recitation.

### DETAILED DESCRIPTION

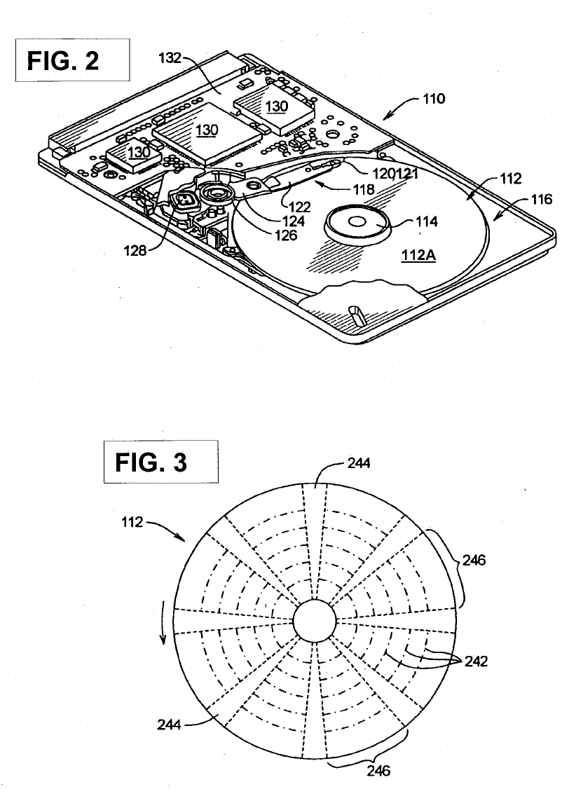

FIG. 2 is a perspective view of a disk drive 110 that can benefit from embodiments of the invention as described herein. For clarity, disk drive 110 is illustrated without a top cover. Disk drive 110 includes a storage disk 112 that is rotated by a spindle motor 114. Spindle motor 114 is mounted on a base plate 116. An actuator arm assembly 118 is also mounted on base plate 116, and has a slider 120 mounted on a flexure arm 122 with a transducer head 121 constructed thereon that includes a read head and a write head. Flexure arm 122 is attached to an actuator arm 124 that rotates about a bearing assembly 126. Voice coil motor 128 moves slider 120 relative to storage disk 112, thereby positioning transducer head 121 over the desired concentric data storage track disposed on the surface 112A of storage disk 112. Spindle motor 114, transducer head 121, and voice coil motor 128 are coupled to electronic circuits 130, which are mounted on a printed circuit board 132. The electronic circuits 130 include a read channel, a microprocessor-based controller, and random access memory (RAM). For clarity of description, disk drive 110 is illustrated with a single storage disk 112 and actuator arm assembly 118. Disk drive 110, however, may also include multiple storage disks 112 and multiple actuator arm assemblies 118. In addition, each side of disk 112 may have an associated transducer head 121, both of which are collectively coupled to the rotary actuator 130 such that both transducer heads 121 pivot in unison. The invention described herein is equally applicable to devices wherein the individual heads are configured to move separately some small distance relative to the actuator. This technology is referred to as dual-stage actuation.

FIG. 3 illustrates storage disk 112 with data organized in a typical manner after disk drive 110 has performed self servo-write (SSW). Storage disk 112 includes concentric data storage tracks 242 located in data sectors 246 for storing data and which are positionally defined by servo information written in servo wedges 244 during SSW. Each of concentric data storage tracks 242 is schematically illustrated as a centerline, but in practice occupies a finite width about a corresponding centerline. Substantially radially aligned servo wedges 244 cross concentric data storage tracks 242 and contain servo information in servo sectors in concentric data storage tracks 242. Such servo information includes a reference signal, such as a sinusoidal wave of known amplitude, that is read by transducer head 121 during read and write operations to position the transducer head 121 above a desired track 242. In practice servo wedges 244 may be somewhat curved, for example, configured in a shallow spiral pattern, but such a spiral pattern should not be confused with the servo spirals used during SSW to generate servo wedges 244. Typically, the actual number of concentric data storage tracks 242 and servo wedges 244 included on storage disk 112 is considerably larger than illustrated in FIG. 3.

In operation, actuator arm assembly 118 sweeps an arc between an inner diameter (ID) and an outer diameter (OD) of storage disk 112. Actuator arm assembly 118 accelerates in one angular direction when current is passed through the voice coil of voice coil motor 128 and accelerates in an opposite direction when the current is reversed, allowing for control of the position of actuator arm assembly 118 and the attached transducer head 121 with respect to storage disk 112. Voice coil motor 128 is coupled with a servo system known in the art that uses positioning data read by transducer head 121 from storage disk 112 to determine the position of transducer head 121 over concentric data storage tracks 242. The servo system determines an appropriate current to drive through the voice coil of voice coil motor 128, and drives said current using a current driver and associated circuitry.

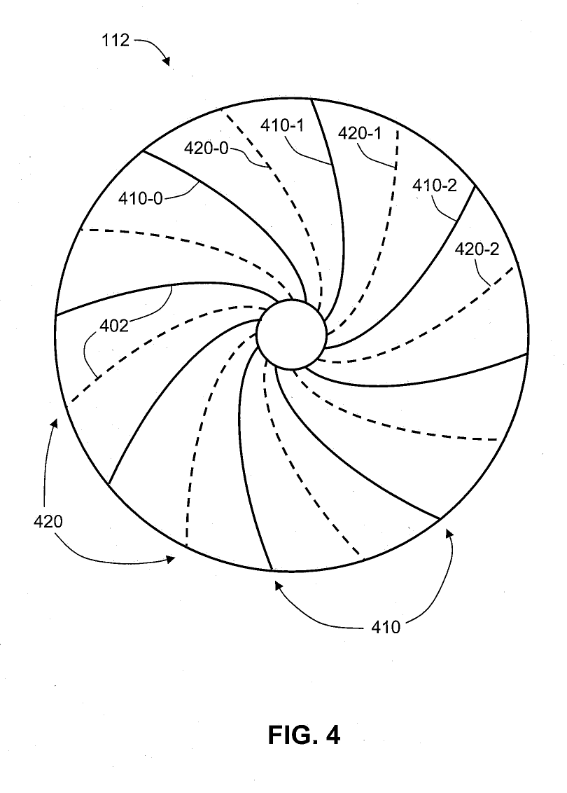

Embodiments of the invention contemplate a method for switching servo control from a first servo spiral set to a second servo spiral set during SSW that prevents relative radial placement and signal coherency issues from being present in the resultant data storage tracks, issues that are known to occur with SSW. Specifically, these issues occur at radial locations defined by the final wedges corresponding to the spiral set switch points during spiral SSW process. At such locations, final wedge position information and signal frequency and coherency are defined by two SSW-write operations—one immediately before and one immediately after the spiral set switch. FIG. 4 illustrates storage disk 112, prior to undergoing a SSW process. Storage disk 112 has two servo spiral sets 410, 420 written thereon. Servo spiral set 410 (solid spirals) and servo spiral 420 (dashed spirals) each contain at least N servo spirals 402, where N is equal to the number of final servo wedges, i.e., servo wedges 244, that will be written to storage disk 112 during SSW. As shown, each servo spiral 402 is circumferentially spaced from adjacent spiral tracks by a substantially equal spacing and is written over one or more revolutions of storage disk 112. In addition, the N servo spirals 402 of servo spiral set 410 and the N servo spirals of servo spiral set 420 are written alternately about the circumference of storage disk 401, to facilitate the switching of servo control from one servo spiral set to the other during SSW. Thus, servo spiral set 410 includes servo spirals 410-0, 410-1, 410-2, 410-3, etc., and servo spiral set 420 includes servo spirals 420-0, 420-1, 420-2, 420-3, etc. It is noted that the number N of servo wedges 244 is typically relatively large, thus the actual number of servo spirals 402 written on storage disk 112 is considerably larger than that illustrated in FIG. 4. It is further noted that the “steepness” of servo spirals 402 may be greater or less than that illustrated in FIG. 4. For example, servo spirals 402 may instead be written at a very “shallow” angle, i.e., over multiple revolutions of storage disk 401. Further, storage disk 112 may include one or more additional servo spiral sets, but for ease of description storage disk 112 is limited to servo spiral sets 410, 420.

As is known in the art, each servo spiral 402 includes timing and position information that enables the servo system of a disk drive to servo over a particular radial location on storage disk 112 during SSW. For example, each spiral track may comprise a high frequency signal interrupted periodically by a sync mark. Off-track information for servoing transducer head 121, i.e., position error signal (PES), may then be determined during SSW by shifts of the amplitude in the spiral pattern detected from the high frequency signal in the spiral track relative to the sync marks in the spiral track. Timing information for controlling frequency of the SSW-written final wedge signal may be determined from the sync marks in the spiral track.

FIG. 5 is a partial schematic diagram of N servo wedges 244 in the process of SSW, where N is total the number servo wedges 244 being written to storage disk 112. For purposes of this description, the SSW process in FIG. 5 takes place from ID to OD; however it is understood that embodiments of the invention are equally applicable to as SSW process that takes place from OD to ID of a storage disk or a combination of both directions. As shown, servo wedges 1, 0, and N−1 are partially written since transducer head 121 (not shown for clarity) is in the process of traversing storage disk 112 from ID to OD one radial spiral track location at a time. Specifically, transducer head 121 servos over one radial track location, e.g., 501, 502, 503, etc., and writes an appropriate servo pattern 520 at the end of each servo wedge 244 and centered on the desired radial spiral track location, then moves to the next radial spiral track location to repeat this process. Upon completion of SSW, one or more of radial track locations 501-504 will correspond to one of the concentric data storage tracks 242 in FIG. 3.

As part of the SSW process, the servo system for disk drive 110 uses servo timing and position information provided by spirals 402 from one servo spiral set, i.e., an “active” servo spiral set, in order to servo transducer head 121 over a desired radial spiral track location during SSW. Additional servo spiral sets are considered “inactive,” and are not used for servo control of transducer head 121 until servo control has been switched thereto. For example, in the embodiment illustrated in FIG. 5, transducer head 121 servos off of either servo spiral set 410 or servo spiral 420, but not both simultaneously. In addition, as transducer head 121 nears the OD of storage disk 112, the write head may lead the read head by one or more radial track locations, which means the read head reads timing and position information from servo spirals that are unavailable or that have been overwritten in some locations by servo patterns 520. Thus, to maintain precise radial positioning of transducer head 121, servo control is switched from the active servo spiral set to a previously inactive servo spiral set when the read head approaches a radial position at which the position and/or timing information of the active servo spiral set cannot be used. The radial position at which servo control switching takes place is a so-called “spiral set switch point.”

Embodiments of the invention contemplate a method for switching servo control from an active servo spiral set to an inactive servo spiral set that avoids the relative radial positioning and signal coherency issues that otherwise occur due to servo spiral switching. Specifically, prior to switching servo control from the active servo spiral set to the inactive servo spiral set at a switch point, position and/or timing information is collected and decoded from both the active and inactive servo spiral sets. An offset value is calculated between each spiral in the active servo spiral set and each positionally corresponding spiral in the inactive servo spiral set, and the offset values so determined are applied as corrections to the inactive servo spiral set. The modified inactive spiral set is then used to maintain servo control of transducer head 121 for subsequent radial positions in the SSW process, and the active spiral set becomes inactive until servo control is returned thereto at a later spiral set switch point.

An exemplary embodiment is now described with respect to FIG. 5. For ease of description, the radial offset between the read head and the write head of transducer head 121 is only 4 SSW steps in FIG. 5. In practice, such an offset may be on the order of 10 to 20 SSW steps over some locations on disk 112. In FIG. 5, the servo system of disk drive 110 maintains the radial position of transducer head 121 based on position and timing information provided by the N servo spirals 402 contained in servo spiral set 410. The read head of transducer head 121 is positioned over radial track location 501 to read timing and position information from servo spiral set 410, and the write head of transducer head 121 is positioned over radial track location 505 in order to write the appropriate servo pattern 520 for each servo wedge 244 at radial track location 505. Once the servo patterns 520 are written at radial track location 505, transducer head 121 is moved one radial track position closer to the OD of disk 112, so that the read head is positioned over radial track location 502 and the write head is positioned over radial track location 506. As shown, one or more of the servo spirals 402 of servo spiral set 410, i.e., servo spirals 410-0, 410-1, are overwritten at radial track location 502, therefore precise servo control of transducer head 121 cannot be maintained if servo spiral set 410 is used to provide position and timing information to the servo system of disk drive 110. Alternatively, servo spirals 410-0, 410-1, may be overwritten at radial track location 502 due to a previous WRITE command. In either case, switching from servo spiral set 410 to servo spiral set 420 is necessary, and relative radial final track position inaccuracy between servo spiral set 410 and servo spiral set 420 can result in undesirable PES spikes and poor signal coherency during otherwise normal operation of disk drive 110. Instead, according to an embodiment of the invention, position and timing information from servo spiral set 420 is used after being modified by an array of offset values.

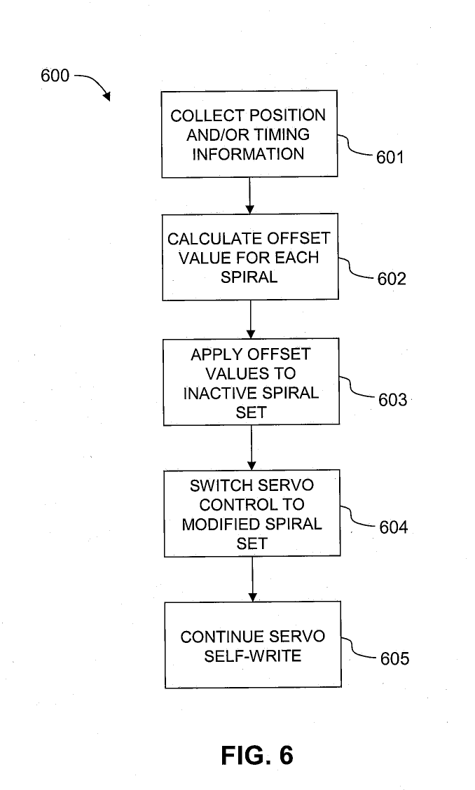

FIG. 6 is a flow chart that summarizes, in a stepwise fashion, a method 600 for switching servo control from an active servo spiral set to an inactive servo spiral set, according to an embodiment of the invention. Method 600 is described in terms of a disk drive substantially similar to disk drive 110 in FIG. 2, however other disk drives may also benefit from the use of method 600. The commands for carrying out steps 601-605 may reside in the disk drive control algorithm and/or as values stored in the electronic circuits of the disk drive or on the storage disk itself. As described above in conjunction with FIG. 5, prior to the first step of method 600, transducer read head 121 reaches a spiral set switch point, in this example radial track location 501.

In step 601, position and/or timing information is collected from the N servo spirals in both the active servo spiral set and the inactive servo spiral set at the current radial position, i.e., radial track location 501. In this example, servo spiral set 410 is the active servo spiral set and servo spiral set 420 is the inactive servo spiral set. The timing and position signals are measured by the read head of transducer head 121 and decoded by the servo system of disk drive 110 to produce a timing and position value for transducer head 121 at each servo spiral 402. Data from the active servo spiral set are denoted “A” and data from the inactive servo spiral set are denoted “I,” and the data set for one revolution having 2N spirals (N spirals in each servo spiral set) is:

A₀, I₀, A₁, I₁ . . . A_{N-2}, I_{N-2}, A_{N-1}, I_{N-1}

The servo system of disk drive 110 continues to use the timing and position data provided by the active servo spiral set, i.e., A₀, A₁ . . . A_{N-2}, A_{N-1}, as the reference for servoing the radial position of transducer head 121. The samples decoded from the active servo spiral set, i.e., A₀, A₁ . . . A_{N-2}, A_{N-1} and the idle servo spiral set, i.e., I₀, I₁ . . . I_{N-2}, I_{N-1}, are stored for use in later steps of method 600.

In one embodiment of step 601, position and/or timing information is collected and then decoded over multiple revolutions of storage disk 112, e.g. on the order of 2-10 revolutions. The decoded position and/or timing value for each servo spiral is then averaged over the multiple measurements taken at each servo spiral. Thus, the values I₀ and Aₒ are each average values of the 0th active and inactive servo spirals, respectively, taken over multiple revolutions. Similarly, I₁ and A₁ are each average values of the 1st active and inactive servo spirals, respectively, taken over multiple revolutions, I₂ and A₂ are each average values of the 2nd active and inactive servo spirals, respectively, taken over multiple revolutions, and so on. In such an embodiment, non-repeatable variations in the measured position and/or timing signals are minimized. Ideally such non-repeatable variations, for example small random movements of transducer head 121 due vibration and turbulence or random fluctuations in the velocity of the spindle motor, can be eliminated through averaging the decoded value of the desired signal over multiple revolutions.

In step 602, an offset value is calculated between each spiral in the active servo spiral set and a corresponding spiral in the inactive servo spiral set. In this way, an offset array of N position and/or timing values is generated. For example, referring to FIG. 5, the decoded position value for servo spiral 410-0 is compared to the decoded position value for servo spiral 420-0, where the difference therebetween equals the 0th offset value stored in a position offset matrix. Similarly, the decoded position value for servo spiral 410-1 is compared to the decoded position value for servo spiral 420-1 to determine the first value stored in the position offset array, and so on. Thus, the 0th position and/or timing value of the offset array may be defined as D₀=I₀−A₀, where D₀, I₀, and A₀, may be a timing value, a position value, or both. In this way, the slight deviation of a servo spiral in the inactive servo spiral set from its corresponding servo spiral in the active servo spiral set is quantified and can be corrected, thereby reshaping the path described by the inactive servo spiral set to substantially parallel the path described by the active servo spiral set.

In step 603, the offset values determined in step 602 are applied to the decoded position and/or timing information for the inactive servo spiral. By modifying the information collected from each servo spiral in the second servo spiral by the appropriate offset value, the active and inactive servo spiral sets define essentially the same position at the spiral set switch point.

In step 604, servo control is switched to the previously inactive servo spiral, in this example servo spiral set 420. In one embodiment, step 604 takes place at the spiral set switch point, i.e., while the write head is still at radial track location 505. In another embodiment, the active servo spiral, i.e., servo spiral set 410, is used for servo control until the write head of transducer head 121 is positioned over the next radial track location, i.e., radial track location 506.

In step 605, transducer head 121 continues traversing toward the OD, i.e., in the SSW direction, of storage disk 112 one radial location at a time and the previously inactive servo spiral, i.e., servo spiral set 420, serves as the active servo spiral set. Servo patterns 520 are then written to servo wedges 244 normally until another spiral set switch point is reached. It is emphasized that when spiral set 420 is used to continue servo control of the write head in the SSW process, position and/or timing information from each of the N servo spirals contained therein is modified with the corresponding offset value from the offset array generated in step 602.

In one embodiment, steps 601 and 602 are performed iteratively over multiple revolutions to reduce the risk of divergence, i.e., instability due to cumulative error, when using method 600. Namely, in a first revolution of storage disk 112, steps 601 and 602 are both performed, i.e., position and/or timing information is collected from the N servo spirals in both the active servo spiral set and the inactive servo spiral set at the current radial position, and an offset value is calculated between each spiral in the active servo spiral set and each corresponding spiral in the inactive servo spiral set. During a second revolution, steps 601 and 602 are repeated so that a second offset is determined between the active servo spiral set and the now corrected inactive servo spiral set. If the second offset meets one or more desired success criteria, then method 600 continues on to step 603. If the criterion or criteria are not met, the offset value for each servo spiral calculated after the first revolution is modified with the second offset value for each spiral and steps 601, 602, are repeated. Alternatively, the offset value for each servo spiral calculated after the first revolution is modified by a factor derived from the second offset value for each spiral. One example of a success criterion is: the sum of the offsets for all N servo spirals has not exceeded a predetermined combined value. Another is: no single servo spiral has been modified by more than a specific value or by more than a specific percentage of its previous value. In such an iterative embodiment, limits may also be imposed on individual values contained in the offset array, to prevent unrealistic offsets caused by random noise from creating instability in the algorithm. For example, position offset values may be limited to no more than a predetermined quantity, such as a percentage of track width.

One advantage of such an embodiment is that the stability of the servo system is enhanced, i.e., small random errors in position or timing are less likely to result in a divergence. Another advantage of such an embodiment is that convergence of the position/timing values of the modified inactive servo spiral set to the corresponding values of the active servo spiral set may take place in a smaller number of revolutions than the averaging approach described above in step 601.

In one embodiment, the offset array of N position and/or timing values generated in step 602 undergoes post-processing prior to step 603 (applying offset values to the decoded position and/or timing from the inactive servo spiral). In order to minimize the risk of divergence and to suppress the effects of noise, a decomposition of the offset array of N position and/or timing values is performed to separate the significant sources of variation between servo spirals from random noise. In such an embodiment, the offset array is decomposed into AC and DC components, so that only the DC (displacement) portion of the offset is applied to the decoded position and/or timing for the inactive servo spiral. Alternatively, one or more of the AC components of the decomposed offset array may also be applied to the decoded position and/or timing from the inactive servo spiral. In such an embodiment, a Fourier transform is taken of the offset array, and one or more of the frequency components having the highest amplitude or a pre-determined value based on empirical and/or design characteristics are used to correct the inactive servo spiral. In one embodiment, only the 1×, 2×, and 3× frequency components of disk revolution are used, since these frequency components, in conjunction with the DC component, are recognized as being the primary contributors to variation of servo spirals from their ideal paths.

In one embodiment, steps 601 and 602 are performed iteratively over multiple revolutions using one or more DC and individual harmonics decomposed from the offset array. In such an embodiment, limits may be imposed on the individual values contained in the offset array. For example, 1× frequency components may be limited to be no more than a predetermined percentage different than in the previous iteration, e.g., 5%, while 3× frequency components may have a different limitation, e.g., 2%. Such an embodiment can increase the stability of method 600 when frequency components are used to determine offset corrections between servo spiral sets.

In one embodiment of the invention, method 600 is performed each time the read head of transducer head 121 reaches a spiral set switch point during SSW. In another embodiment, method 600 is only performed to match a first servo spiral set to a second servo spiral set, but not vice-versa. For example, when servo spiral set 410 is the active servo spiral set and a spiral set switch point is reached during SSW, an embodiment of method 600 is performed to match the time and/or position data of servo spiral set 420 to that of servo spiral set 410. Servo spiral set 420 is then made the active servo spiral set. However, when servo spiral set 420 is the active spiral set and a spiral set switch point is reached, method 600 is not performed to match servo spiral set 410 to servo spiral set 420. Instead, servo control is returned to servo spiral set 410 without modifying servo spiral set 410, since it is assumed that the change in position and/or timing information defined by servo spiral set 410 at one radial track location and a nearby radial track location is not significant. In yet another embodiment, the offset array generated in step 602 is used at multiple spiral set switch points, rather than being generated each time servo spiral set 420 is matched to servo spiral set 410.

In sum, compared to prior art methods of SSW, embodiments of method 600 have the significant advantage of preventing the relative radial placement and signal coherency issues with data storage tracks that are known to occur with SSW. Further, one of skill in the art will appreciate that embodiments of the invention may employ a different number of servo spiral sets than two. In one embodiment, three or more servo spiral sets may be used for spiral set switching. In yet another embodiment, a non-integer number of servo spiral sets relative to the number of final servo wedges may be used for spiral set switching.

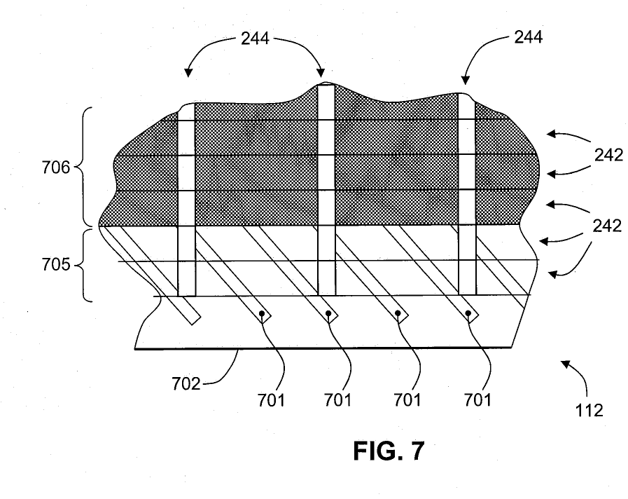

FIG. 7 is a partial schematic diagram of a region of storage disk 112 near the edge of useful data storage stroke thereof after method 600 has been performed, final servo wedges 244 have been written on storage disk 112, and user data has been written on concentric data storage tracks 242 in the area 706 through normal use of disk drive 110. As shown, concentric data storage tracks 242 are well aligned with each other and have no significant separation therebetween caused by servo spiral set switching. User data on concentric data storage tracks 242 is present between servo wedges 244 except near OD 702 of storage disk 112, and near the ID of storage disk 112 (not shown). It is noted that, as an artifact of the SSW process, remainder portions 701 of the over-written servo spirals still remain on the surface of storage disk 112 between user data area 706 and disk edge 702. As shown, servo wedges 244 and remainder portions 701 may both be present in a region free of user data, i.e., in edge region 705.

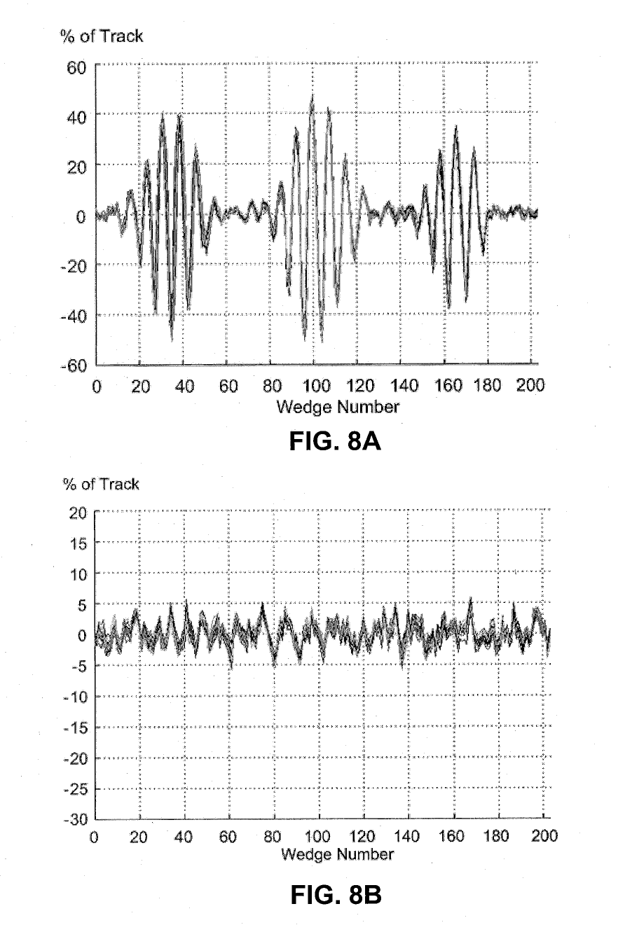

FIGS. 8A, 8B illustrate graphs of PES samples taken, respectively, from a disk drive manufactured using a standard SSW procedure and an identical disk drive using an SSW procedure modified by an embodiment of method 600 described above. PES values were measured and decoded for each servo wedge of a disk over multiple revolutions while servoing on the final wedges at the radial location corresponding to the spiral set switch point during SSW process. At such locations final wedge position information is defined by two SSW-write operations—one immediately before and one immediately after the spiral set switch. The PES values were then converted to an equivalent percentage of track width (represented by the ordinate), and are presented as a function of servo wedge number (represented by the abscissa), where the disk consists of 204 servo wedges. The PES spikes in FIG. 8A indicate significant mismatch between shapes of final tracks located immediately before and immediately after spiral switch points some causing written-in position errors as great at 40% of track width. A strong 3×-based PES degradation is apparent in FIG. 8A, in which the majority of track variance fluctuates at three times the frequency of revolution of the disk. In FIG. 8B, track variance is no greater than about 5% for any servo wedge, and the 3×-based degradation is absent.

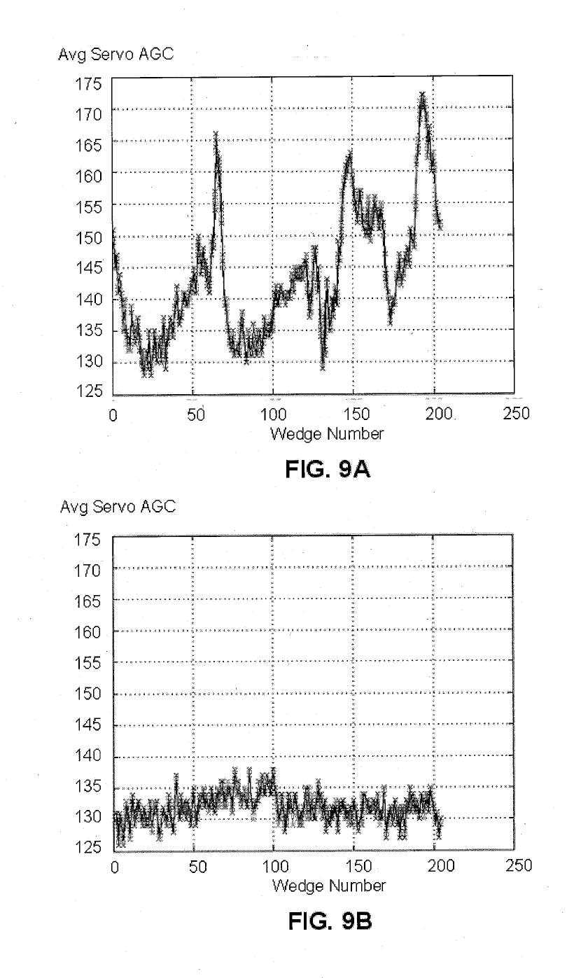

FIGS. 9A, 9B illustrate automatic gain control (AGC) samples from the read channel taken, respectively, from a disk drive manufactured using a standard SSW procedure and an identical disk drive manufactured using an SSW procedure modified by an embodiment of method 600 described above. Higher AGC values generally indicate lower amplitude and worse coherency of final servo wedge signal. AGC values were measured for each servo wedge of a disk over multiple revolutions while servoing on the final wedges at the radial location corresponding to the spiral set switch point during SSW process. At such locations final wedge signal frequency and coherency are defined by two SSW-write operations—one immediately before and one immediately after the spiral set switch AGC values (represented by the ordinate) are presented as a function of servo wedge number (represented by the abscissa), where the disk consists of 204 servo wedges. Spikes in AGC values indicate incoherency, i.e., servo signal timing differences, at many of the final servo wedges, revealing a systematic problem with spiral switching. AGC values as great as 170 are indicated. In FIG. 9B, no spikes in AGC values are present values for most wedges fall below 135, indicating there are no significant coherency issues with servo wedges on this disk.

While the foregoing is directed to embodiments of the present invention, other and further embodiments of the invention may be devised without departing from the basic scope thereof, and the scope thereof is determined by the claims that follow.

I claim:

1. A method of writing servo wedges on a recording medium having first and second sets of spirals written thereon, wherein each spiral in the second set is written on the recording medium between two spirals in the first set, said method comprising:
determining a correction factor based on differences between the first and second sets of spirals;
at a first radial position of the recording medium, writing components of the servo wedges on the recording medium based on values decoded from the spirals in the first set; and
at a second radial position of the recording medium, writing components of the servo wedges on the recording medium based on values decoded from the spirals in the second set,
wherein the values decoded from the spirals in the second set are modified with the correction factor prior to the components of the servo wedges are written on the recording medium.

2. The method according to claim 1, wherein the correction factor is determined from differences in the values decoded from the spirals in the first set and the values decoded from the spirals in the second set, and the values decoded from the spirals in the first set are not modified with any correction factor prior to the components of the servo wedges are written on the recording medium.

3. The method according to claim 2, wherein the correction factor is a mean of the differences.

4. The method according to claim 2, further comprising:
computing a Fourier transform of the differences,
wherein the correction factor includes a first-order correction factor equal to the 1× frequency component of the Fourier transform, a second-order correction factor equal to the 2× frequency component of the Fourier transform, and a third order correction factor equal to the 3× frequency component of the Fourier transform.

5. The method according to claim 1, wherein position values are decoded from the spirals and the correction factor is a positional correction factor.

6. The method according to claim 1, wherein timing values are decoded from the spirals and the correction factor is a timing correction factor.

7. The method according to claim 1, further comprising:
decoding position values for the first radial position from the spirals in the first set; and
decoding position values for the first radial position from the spirals in the second set,
wherein the correction factor is determined from differences in the position values decoded from the spirals in the first set and the position values decoded from the spirals in the second set.

8. The method according to claim 1, further comprising:
decoding timing values for the first radial position from the spirals in the first set; and
decoding timing values for the first radial position from the spirals in the second set,
wherein the correction factor is determined from differences in the timing values decoded from the spirals in the first set and the timing values decoded from the spirals in the second set.

9. A method of writing servo wedges on a recording medium having first and second servo spirals written thereon, said method comprising:
collecting information from the first servo spiral and the second servo spiral;
positioning a transducer head over a first radial position of the recording medium using the information collected from the first servo spiral;
writing components of the servo wedges on the recording medium at the first radial position using the information collected from the first servo spiral;
positioning the transducer head over a second radial position of the recording medium using the information collected from the second servo spiral; and
writing components of the servo wedges on the recording medium at the second radial position,
wherein the information collected from the second servo spiral is corrected based on a correction factor and the corrected information is used in positioning the transducer head over the second radial position of the recording medium and in writing the components of the servo wedges on the recording medium at the second radial position.

10. The method according to claim 9, wherein the collected information is position information and the correction factor is a position correction factor.

11. The method according to claim 9, wherein the collected information is timing information and the correction factor is a timing correction factor.

12. The method according to claim 9, wherein the information collected from the first servo spiral is not corrected based on any correction factor and the uncorrected information is used in positioning the transducer head over the first radial position of the recording medium and in writing the components of the servo wedges on the recording medium at the first radial position.

13. The method according to claim 9, further comprising:
collecting information from additional spirals that are written on the recording medium and associated with the first servo spiral and additional spirals that are written on the recording medium and associated with the second servo spiral, and
determining the correction factor as a mean of the differences between the information collected from the first servo spiral and the additional spirals associated with the first servo spiral and the information collected from the second servo spiral and the additional spirals associated with the second servo spiral.

14. The method according to claim 13, further comprising:
computing a Fourier transform of the differences between the information collected from the first servo spiral and the additional spirals associated with the first servo spiral and the information collected from the second servo spiral and the additional spirals associated with the second servo spiral,
wherein the correction factor includes a first-order correction factor equal to the 1× frequency component of the Fourier transform, a second-order correction factor equal to the 2× frequency component of the Fourier transform, and a third order correction factor equal to the 3× frequency component of the Fourier transform.

15. The method according to claim 13, wherein each of the second servo spiral and the additional spirals associated with the second servo spiral is written on the recording medium between two of the first servo spiral and additional spirals associated with the first servo spiral.

16. The method according to claim 9, wherein the information is collected from the first servo spiral and a second servo spiral over multiple revolutions and then averaged.

17. A recording medium comprising:
a plurality of servo wedges written on the recording medium; and
a circumferential edge portion having parts of servo spirals written thereon at substantially evenly spaced apart intervals,
wherein the servo wedges are written on the recording medium using a first set of the servo spirals, a second set of the servo spirals, and at least one correction factor that accounts for differences between the first set of the servo spirals and the second set of the servo spirals.

18. The recording medium according to claim 17, wherein the differences are differences in position values decoded from the first set of spirals and position values decoded from the second set of spirals.

19. The recording medium according to claim 17, wherein the differences are differences in timing values decoded from the first set of spirals and timing values decoded from the second set of spirals.

20. The recording medium according to claim 17, wherein components of the servo wedges that define a first set of tracks are written using the first set of the servo spirals, and components of the servo wedges that define a second set of tracks are written using the second set of the servo spirals and the correction factor.
